(19) United States
(12) Patent Application Publication
(10) Pub. No.: US 2002/0076360 A1
(43) Pub. Date: Jun. 20, 2002

(54) System for treatment of animal waste

(75) Inventors: Dov Ingman, Haifa (IL); Vladimir M. Ogenko, Kiev (UA)

Correspondence Address: Troy M. Schmelzer, PROCOPIO, CORY, HARGREAVES & SAVITCH LLP, Suite 2100, 530 B Street, San Diego, CA, 92101-4469, US

(73) Assignee: Innovative Material Solutions, LLC

(21) Appl. No.: 09/961,426

(22) Filed: Dec. 11, 2001

Related U.S. Application Data
(62) Division of application No. 09/524,945, filed on Mar. 14, 2000.

(30) Foreign Application Priority Data
Dec. 7, 1999 (IL) 133,364

(51) Int. Cl. A61L 11/00; A61L 9/014

(52) U.S. Cl. 422/122; 422/5

(57) ABSTRACT

The present invention relates to a method for treatment of liquid or semi-liquid animal waste using porosive particulate matter to remove malodorous materials, and to an organic fertilizer composition comprising organic substances derived from animal waste, said organic substance being held in pores of porosive, nutritionally inert particulate matter.

### RELATED APPLICATIONS

This application is related to and claims priority to the Israeli Patent Application Serial No. 133,364, filed Dec. 7, 1999, by Ingman and Ogenko, and entitled “A METHOD AND SYSTEM FOR TREATMENT OF ANIMAL WASTE,” which is hereby incorporated herein by reference in its entirety, including any drawings.

### FIELD OF THE INVENTION

This invention relates to the field of waste management and particularly to a method for the treatment of animal manure, to compositions useful for such treatment as well as to the uses of the products obtained by said treatment.

### BACKGROUND OF THE INVENTION

Animal manure, particularly its odor and excessive nutrient concentrations, are a serious and a growing problem, especially in the field of commercial animal husbandry. There is a global need for the development and improvement of waste management and odor control facilities and method associated with animal husbandry, e.g. in the beef cattle industry, dairy industry, poultry industry and in swine industry.

Manure can be handled as a liquid, a semi-solid or a solid. The amount of bedding and dilution water influences manure characteristics. These characteristics affect the type of manure management system suitable for waste treatment. Typically, solid manure is a combination of urine, bedding and feces with no additional water added. Semi-solid manure has little bedding and no extra liquid is added, while liquid manure has water added to form a floatable mixture.

Many factors have to be considered when choosing the type of manure management system for a specific animal production operation. These include: the livestock type (cattle, hogs, poultry), the age and size of animal, the feed required, the housing system, the bedding required or available, the cropping practice of the area, proximity to waterways, proximity to neighboring residential areas and the personal preference of the livestock grower.

The most common and basic manure treatment facility is the lagoon system, which may be used regardless of the animal managed in the operation. Lagoons originated as a means of storing and conserving fertilizer nutrients from the waste of animals up until the time it was applied directly to the soil.

Lagoons act as digesters in which two major types of bacteria decompose organic matter into liquids and sludge: anaerobic bacteria, typically present in the intestinal tract of warm blooded animals and are active under oxygen-free conditions; and aerobic bacteria which are active only in the presence of dissolved oxygen, resulting either from diffusion across the water surface of the lagoon, or as a result of photosynthesis by algae. Lagoon systems, however, yield a loss of nutrient value. Further, as malodors are prevalent in most lagoon systems, frequent sludge removal is required, especially if the lagoon is undersized for the operation and there is a need for water level control and mechanical aeration systems to keep the lagoon in operation. Such removal may increase the cost of the operation.

The malodors released from the manure present a major environmental problem. Odor in livestock operations is the direct result of the decay of organic materials, be it feces or feed products and the resulting high concentrations of ammonia, hydrogen sulfide, carbon dioxide, trace gases, volatile organic compounds, methane dust and some pathogens.

The odor may be treated by ventilation, either by natural wind-propelled ventilation by mechanical ventilation using fans, ventilation, tunnels, etc. Alternatively, the released odor may be reduced by the use of biofilters or biomass filters, or by covering the storage structures (e.g., lagoon) with either high density polyethylene materials or straw, corn stalks, etc., the latter having the limitation that they become soaked with water and thus sink, thereby contributing to manure solid and odor problems in the storage tank.

### SUMMARY OF THE INVENTION

The present invention provides a novel system and method for the treatment of animal waste. The term “animal waste” as used herein refers to a solid, semi-liquid or liquid animal manure compositions as noted above. The animal waste includes feces, typically also urine, and at times, also animals bedding material and food remains.

In accordance with the invention, the animal waste, in a liquid or semi-liquid form, is treated within a receptacle suitable for collecting such waste. In the case the animal waste is solid, it may be treated by diluting it with water. The receptacle may be a receptacle which directly receives the animal waste preferably positioned underneath the animal growing facility. Alternatively, the receptacle may be a reservoir situated outside the animal growing facility to which the animal waste is transferred through pipes or channels, by the use gravity caused flow or various pumping arrangements, etc. the receptacle containing the animal waste will be referred to herein as the “animal waste pool”.

In accordance with the invention, an interface layer is formed over the upper face of the animal waste pool. This interface layer comprises particulate matter which acts in changing the properties and composition of the upper pool layer by virtue of the interface layer functional properties. Such functional properties include one or more of the ability to absorb organic matter present the pool, ability to catalytically act in degrading volatile malodorous substances, the ability to form a barrier for gas transfer between the pool and the external atmosphere (particularly transfer of oxygen from the atmosphere into the pool and evaporation of volatile malodorous substances from the pool to the surrounding atmosphere) or, if desirable, the ability to biologically degrade organic waste through bacteria which are contained within the interface layer.

The interface layer may comprise different kinds of particulate matter, ranging in size between nano particles (particles in a diameter range of 5-500 nanometer), micro-particles (particles ranging in size between about 1 μm-500 μm) and macro-particles (particles ranging somewhere between one millimeters to a few centimeters). Typically, but not exclusively, nano-particles will be sorbed onto micro-particles or macro-particles, to avoid their dispersion by air movement. Similarly, the micro-particles may also be sorbed onto macro-particles.

The particulate matter forming the interface layer may be of different types, such as silica; processed mineral particles; active carbon; plant-material residues (wood pieces, wood pulp, sawdust, straw, etc.) and preferably a combination of such substances. In addition, the interface layer forming material may be pre-treated to have special beneficial characteristics, as will be detailed below.

One important effect of a treatment in accordance with the invention is the prevention or reduction in malodors typically associated with such waste. Furthermore, another beneficial effect of the treatment in accordance with the invention as at times the obtaining of a fertilizer composition. The fertilizer composition in accordance with the invention comprises at least some of the material which is formed, during treatment, in the interface layer or inherently present in the animal waste pool (such material will be referred to herein at times as “interface layer material”).

Provided by the invention is a system and method for waste management. Also provided by the invention are particulate matter for use as interface layers in the inventive method and system. Still further provided by the invention are fertilizer compositions obtainable in accordance with the invention.

The particulate matter which form an interface layer is pre-treated in a manner so as to enable it to float over the surface of the liquid for a period of time. Such a treatment may include sintering (forming closed gas/air filled pores which render the particulate matter floatable); chemical modification of the particulate matter to make it hydrophobic; binding catalytic compounds to the particulate matter; sorbing of particulate matter of various sizes to one another; impregnating the particulate matter with bacteria, typically aerobic bacteria, which then colonize the pores in the material. It should be noted that an important requirement of the particulate matter is that it has an overall specific gravity less than that of water so that it will remain afloat on the top surface of the waste pool. With some of the particulate matter used as the interface layer material, this may be a result of the porosity of the particles and the sintering thereof to close some of the pores to form closed air pockets. The porosity of the particles used in accordance with the invention is typically above 50% and preferably within the range of 50-95%. Alternatively, or in addition, some of the material forming the interface layer may be chemically treated to render it hydrophobic, as will be detailed further below.

At times, as already mentioned above, the particles may be treated by binding or absorption thereto catalytic components, e.g. photo catalysts. Examples of catalysts are heavy metal complexes or oxides, such as titanium oxide (TiO₂). The catalysts, if present on the particles, serve for the degradation of volatile organic matter released from the waste pool. This reduces the malodors which are typically associated with animal waste. It should be noted that silica or some minerals have some catalytic properties by their own right nevertheless, may be combined with other catalytic component to yield a more pronounced effect.

The invention thus provides a method for treatment of liquid or semi-liquid animal waste, comprising:

(One) collecting the animal waste into a receptacle, to form a waste pool;

(Two) introducing onto the waste pool floatable porosive particulate matter which forms an interface layer over a top surface of said pool, said interface layer having an effect on the composition of the pool's upper layer or its interaction with the overlaying atmosphere; and

(Three) incubating said particulate matter in said pool for a time sufficient to yield said effect, while periodically, if necessary, replacing or replenishing the interface layer with new such said matter.

The said effect may, in accordance with one embodiment, be the prevention of reduction of malodors. For that purpose, the treatment in accordance with the invention will proceed at least for a time until the waste material solidified or otherwise change its properties to avoid malodor.

In accordance with a preferred embodiment of the invention, said effect comprises absorption or degradation of organic matter in the upper layer. The particulate matter, which in accordance with the invention form part of the interface layer, may be treated to render it or at least part thereof hydrophobic and consequently, organic material will be absorbed within pores and thereby be removed from the waste pool. This will give rise to depletion of organic material from the pool's upper layers which will give rise to some drift of organic material from lower layers to upper layers. If necessary, the interface layer may be replaced or replenished with fresh interface layer forming material thereby retaining the capacity to continuously absorb organic material from the pools' upper layers.

In accordance with another embodiment, the porosive particulate matter may be impregnated with bacteria as mentioned above.

The present invention also provides a system for the treatment of liquid or semi-liquid animal waste, comprising:

(One) a receptacle for receiving the animal waste to form a waste pool;

(Two) floatable porosive particulate matter for forming an interface layer over a top surface of said pool, said interface layer having an effect on the composition of the pool's upper layer or its interaction with the overlaying atmosphere.

Also provided by the invention is a particulate matter useful for forming said interface layer.

The animal waste is treated to eventually obtain a particulate product useful as a fertilizer. Such fertilizer composition, which is substantially detoxified and contains used, interface layer-forming material, is also an aspect of the invention.

The system of the invention may also comprise means for heating the animal waste to accelerate the waste treatment process. Such heating means may, for example, comprise solar heating means. In particular, waste treatment facility may be covered by a greenhouse-like structure to obtain a greenhouse heating effect.

### DETAILED DESCRIPTION OF A PREFERRED EMBODIMENT

Animal waster including excreta, food remains, and animal bedding typically accumulate in husbandries of commercial animal production. Such accumulated substances need to be properly managed. The present invention provides, inter alia, a method and system for managing waste associated with animal production, in which the organic substances and malodor resulting therefrom are decomposed and/or adsorbed by the novel porosive particulate matter of the invention.

The particulate matter of the invention form on the top surface of the animal waste pool an interface layer. This interface layer-forming material is maintained in the waste pool for a time sufficient to obtain an effect on the composition of the pool's upper layer or on its interaction with the overlaying atmosphere. The effect may include reduction of malodors associated with animal waste, the reduction organic composition in the pool either by its absorption onto the particulate matter or degradation thereof etc. During the treatment the particulate matter may either be replaced or replenished with new such matter. In addition, water or any other suitable liquid may be added to the pool, especially if the waste in the pool has undesirably solidified. The used particulate matter removed from the pool may optionally be dried. The particulate matter removed from the pool is essentially free of malodors and contain a substantial amount of organic substances. This organic material-carrying particulate matter can then be used as fertilizers, which may be supplemented, with additional plant nutritional substances, e.g. Na₂O and K₂O. It should be noted that the particulate matter as such are preferably nutritionally inert, and only when having sorbed thereon organic substances may be useful for fertilization.

The particulate matter of the invention typically has 50-95% porosity, with pores of various sizes.

The interface layer containing the particulate matter floats on the liquid waste. This floatability characteristic of the interface material may be obtained by prior treatment of the particulate matter or at least part thereof. According to one embodiment of the invention, the porosive particulate matter is sintered, which results in closing of part of the pores to yield air-filled voids. Alternatively, or in addition, the particulate matter or part thereof may be chemically modified to become at least at its surface layer, hydrophobic. Such hydrophobic particulate matter will then form a layer on top of and separate from the aqueous medium.

Hydrophobic particulate matter may be obtained by various procedures known to the artisan. The procedure employed may depend, inter alia, on the material from which the particulate matter is made of. According to one embodiment, at least part of the interface forming particulate matter is an oxide-containing substances, which typically contain hydroxyl groups on their surface. The hydroxyl groups may be reacted to bind hydrophobic groups, such as alkyl, e.g. methyl groups thereto. The binding is preferably covalent, however may be such that in the presence of water undergo hydrolysis and be released from the interface layer as, for example, an alcohol. As a result, the “hydrolized” particulate matter regains its hydrophilic nature which may result in its sinking in the aqueous medium. Evidently, the binding may also be non-covalent, e.g. ionic, by means of hydrogen bonds, etc.

According to one embodiment of the invention, there will be no subsequent dissociation of the hydrophobic moieties from the particulate matter and the particulate matter will continuously float at the top surface of the waste pool until being manually removed.

According to one embodiment of the invention the chemical modification of the particles is an alkylation, preferably with lower alkyl moieties and more preferably with methyl groups. Methylation of functional groups, such as hydroxyl groups, is a well know procedure. In general, particles, e.g. silica containing particles (SiO₂) are first heated to removed physically absorbed water therefrom, then, the particles are reacted with a suitable reagent, such as methylchloride-silane or poly-siloxane at elevated temperatures, wherein the methyl groups become chemically bound to the surface of the particles. The reaction duration, concentration of methylating reagent and temperature employed during the reaction will determine the degree of methylation and thus the floatation characteristics of the particle.

To form a reversible modification of the particulate matter, i.e. wherein the hydrophobic groups are subsequently hydrolyzed, a similar treatment may be performed, however at lower temperatures and using different reagents, such as butylhydroxysilane. At times, depending on the type of reagents used and as a result of hydrolysis of the hydrophobic moiety, alcohol may dissolve into the aqueous medium. The dissolved alcohol may then inhibit any bacterial degradation (preferably anaerobic) occurring in the anoxic areas of the liquid, thereby minimizing the conversion of the organic substances in the waste into methane gas. Such inhibition is desirable to prevent full degradation of organic material which becomes absorbed by the particulate matter, thus permitting the use of these organic material-carrying compositions, for example as fertilizers.

It will be appreciated by the artisan that the interface layer formed at the top surface of the waste pool may contain particulate matter treated by more than one of the above described prior treatments or equivalents thereof or by any other one or more treatments to render the particulate matter floatable. Thus, a particle may be both sintered and carry chemically bound hydrophobic substances thereon. Further, the interface layer may comprise particulate matter having different levels of hydrophobicity.

The particulate matter of the invention may be treated silica particles, treated mineral particles and/or treated plant material residues, all of which are known to contain a significant content of oxides. Further, the particles may be of a porosive hydrophobic polymer, such as hydrophobic polyesters or any other porosive material which is or may be treated to become a floatable material.

Within the scope of the present invention, mineral particles include, but are not limited thereto, silica minerals, e.g. perlites, clay minerals, e.g. bentonite and claydite or alumina minerals or any other mineral being porosive and containing a significant content of oxides. Plant material residues include, but are not limited thereto, husk straw, peat, dry stems, sawdust, etc.

The invention also provides method steps and means for treating malodor associated with animal waste. As described above, malodor associated with animal manure and food remains is a major problem in the field of commercial animal husbandry. Thus, it is specially desirable to have a system and a method which will prevent the formation and thereby the release of such odors into the surrounding atmosphere. According to one embodiment, the volatile materials are decomposed by a catalytic component present in the interface layer at the top surface of the waste pool. Such catalytic components are preferably photo-catalysts which may be known to the person versed in the art. They include, but are not limited thereto, heavy metal complexes, such as complexes of Fe, Cu, Co, or Ni or metal oxides, such as TiO₂ or Al₂O₃. The catalytic components may be either dispersed in the interface layer or be adsorbed onto the porosive particulate matter. One way of sorbing the catalytic components onto the porosive particulate matter is by means of electrostatic interactions. This may be accomplished by spraying the mixture of particulate matter and catalytic components with a hot and dry air (optionally ionized), which gives rise to build-up of electrostatic charges on the particles.

According to a further embodiment, the formation of malodor is prevented as a result of the structuring of the interface layer, i.e. a crust-like layer is formed at the top surface of the pool which prevents the biodegradation of organic substances within the pool, which in return, prevents the formation of malodor associated with such decomposition of organic matter.

The particulate matter of the invention may be of various sizes ranging from nano-particles having a diameter in the nanometer scale, preferably in the range of 5-500 nanometers, micro- or macro-particles, having a diameter in the range of one or more millimeters to several centimeters. As the nano-particles have a greater specific surface area than micro- or macro-particles, such nano-particles are preferable in the method and system of the invention. However, it will be appreciate that when using very small floatable particles there is the possibility that they will be drawn away from the pool by air movement. Thus, according to the present invention it is preferable that the nano-particles be sorbed onto floatable micro- and/or macro-particles. The nano, micro- and macro-particles may be of the same or different material and they may be subjected to the same or different pre-treatment. The sorption of nano-particles onto micro- or macro-particles may be achieved, for example, in the manner described above in connection with the adsorption of catalytic components onto the particulate matter or by any other suitable means for association of the two particulate matter's types.

According to a further embodiment of the invention, the interface layer may further comprise active carbon particles (e.g. graphite, carbon particles). Active carbon particles are known to absorbed gases and may thus prevent or at least reduce the amount of noxious odors released from the waste pool. Further, as such particles are typically black, they may function to absorb sunlight and heat the pool facilitating the biological degradation process. At times, the system may comprise other or additional heat-absorbing particles, such as dark-colored rubber particles, e.g. such prepared from used tires. Heating means with a greenhouse-like cover structure may also be used for pool warming.

Yet further, the interface layer may comprise bacteria, preferably aerobic bacteria, carried by the pores of the particles for biological degradation of the organic substances in the animal waste. The bacteria are typically contained in macro-pores having a diameter in the range of about 1 to about 50 micron, while micro-pores, having a diameter in the range of 1 Å to 1 micron may function as trap means for the organic substances (the organic substances will be sorbed in these traps by hydrophobic interaction). The aerobic bacteria will lead to the partial decomposition of the organic matter which may at times be desirable. The bacteria may originate from the waste in which bacteria is inherently present or from impregnation of the particles with such bacteria prior to their introduction into the waste-containing pool. Commercially available bacterial cultures may be used for the impregnation of the porosive particulate matter with the desired bacteria.

The method of the invention may be a batch process, wherein waste is introduced into the receptacle only at the beginning of the treatment, or a continuous process, wherein animal waste is periodically added to the pool. In any case, the interface layer forming material may be replaced or replenished with new particulate matter several times during the waste treatment procedure. The particulate matter is preferably collected, optionally dried, and may then be subsequently used as fertilizing compositions as described above. The advantage of such fertilizer compositions is that the organic substances accumulated in the pores of the particulate matter will be released into the soil in a slow release manner.

### EXAMPLES

Preparation of butylated silica nano-particles

Silica nano-particles (diameter of 5-500 nanometer) were modified by reacting the same with hydroxybutyl silane or butanol to yield hydrophobic butylated silane particles. Excess of butanol was removed from the system by evaporation. The particles were then heated at 200-300° C. followed by their cooling at room temperature to yield a white powder-like particulate matter.

Urine Treatment with Butylated Silica Nano-particles

Silica particles modified by butyl radicals (16 gr.) were introduced step-wise (eight portions, 2 gr. Each) into a beaker containing a sample of swine urine (200 ml), until obtaining a snow-like interface layer at the top surface of the liquid. After each addition of nano-particles the system was mixed for 2-3 min. The initial pH of the system was 6.0, and the treatment was carried out at 18° C., with air humidity of 65%.

The malodors associated with the urine were substantially eliminated after less than an hour. After 24 hours the liquid within the beaker obtained a pasty-like structure, substantially free of odors (pH of the liquid was 7.0).

After an additional week, the pasty like substance lost 50% of its weight as a result of water evaporation and became an odorless lumpy powder.

After additional two weeks, the material within the beaker became dry and had a powder-like structure (32 gr) comprised of the particles carrying organic substances, including about 16% (by weight) of ureic acid.

These results indicate that the particles were able to withdraw from the urine the organic substances, prevent the formation and release of odors from the liquid and provide substantially clear water, which evaporated from the system.

Preparation of Methylated Nano-particles

Silica particles were treated to carry methyl groups on the surface thereof by reacting the same with trimethylchloridesilane under gaseous conditions, for an 1 hr, at 250-300° C., during which hydrochloride was released from the system.

The efficiency of butylated or methylated particles, a combination of such particles, or a combination thereof with micro- or macro-particles was determined.

Results

The efficiency of the following particles in preventing the formation and release of malodors was determined: CH₃-silica; C₄H₉-silica; CH₃-silica+C₄H₉-silica (50%:50%); Perlite+CH₃-Silica (98%:2%, pelite diameter 2-3mm); Claydite+CH₃-Silica (98%:2%, claydite diameter 1.5-3cm); and coal particles+CH₃-Silica particles (98%:2%). The treated silica particles were adsorbed onto the mineral derived or coal particles by electrostatic interactions. The tests were conducted as described above. Samples of Pig urine and/or pig excrements were placed in a beaker, onto which the particulate matter, was introduced. The samples included urine alone or urine mixed with water (v/v 1:4); pig excrements alone or excrements mixed with urine (1:1). The time after which odors were no longer discernible above the interface layer was measured. Table I provided the results obtained for each type of particles and samples:

TABLE I
Particles

| | | | CH₃-Silica + | | | |
|---|---|---|---|---|---|---|
| | | | C₄H₉- | Perlite + | Claydite + | Carbon + |
| Sample⁵ | CH₃-Silica | C₄H₉-silica | silica | CH₃-Silica | CH₃-Silica | CH₃-Silica |
| Urea | 40-60 min. | 30 min. | 30 min. | 30 min. | 30-60 min. | 30 min. |
| urea + | 60-90 min. | 30 min. | 30 min. | 30 min. | 30-60 min | 30 min. |
| water | | | | | | |
| Pigs | 30 min. | 30 min. | 30 min. | 30 min. | 30-60 min | 30 min. |
| excrements | | | | | | |
| Excrement + | 40 min. | 30 min. | 30 min. | 30 min. | 30-60 min | 30 min. |
| urea | | | | | | |

These results show that in the presence of the particulate matter of the invention, the formation and release of malodors associated with the animal manure was elimination after a short period of time.

Additional observations obtained for the different particulate matter

CH₃-silica particles: a crust was formed at the top of the system with all samples.

C₄H₉-silica particles: After about 24 hours a paste-like layer was formed at the top surface of the samples, after which a powder-like material containing ureic acid (10%) was obtained. The system containing urea and water became dry after about 12 days. Samples containing pig excrements became a lumpy material wherein the organic material is sorbed onto the particulate matter. When the sample contained a mixture of excrements and urea, the lumpy material was coated with a powder-like substance.

CH₃-silica+C₄H₉-silica: The sample became dry after a week. A lumpy material containing the organic substances the latter sorbed onto the particulate matter was obtained when using excrements as the sample, which was covered with a powder like substance, when the sample contained also urine.

Perlite+CH₃-silica: A powder-like material was obtained when using urine or a mixture of urine and water. A lumpy material was obtained in the case of samples containing excrements which was coated with a powder like material when the sample contained also urine.

Claydite+CH₃silica: A paste like layer was formed a the top surface of the samples after 3-4 days of incubation, independent from the type of the sample.

Active carbon+—CH₃-particles: a clear separation between the aqueous phase and organic phase was observed, especially in the case using samples containing urine and water.

What is claimed is:

1. A method for treatment of liquid or semi-liquid animal waste, comprising:
a. collecting said animal waste into a receptacle, to form a waste pool;
b. introducing onto said animal waste pool floatable porosive particulate matter which forms an interface layer over a top surface of said pool, said interface layer having an effect on said pool's upper layer composition or on its interaction with the overlaying atmosphere;
c. incubating said interface layer in said pool for a time sufficient to yield said effect, while periodically, if necessary, replacing or replenishing the interface layer with new such particles.

2. The method of claim 1, wherein said particles have 50-95% porosity.

3. The method of claim 1, wherein said particulate matter is inherently hydrophobic or is a hydrophilic particulate matter pre-treated to render at least part thereof hydrophobic.

4. The method of claim 3, wherein said particulate matter is an oxide-containing substance.

5. The method of claim 4, wherein said particulate matter is silica-derived particles.

6. The method of claim 4, wherein said particulate matter is mineral-derived particles.

7. The method of claim 6, wherein said mineral particles are selected from the group consisting of silica minerals, alumina minerals, or clay minerals.

8. The method of claim 7, wherein said silica mineral is pertile and said clay mineral is bentonite or claydite.

9. The method of claim 3, wherein said particulate matter is plant material residues comprising amorphous oxides.

10. The method of claim 9, wherein said plant residues are selected from the group consisting of husk straw, peat, dry stems, sawdust.

11. The method of claim 3, wherein said treatment included sintering of the porosive particulate matter, to form air-filled pockets therein which render the particles floatable.

12. The method of claim 3, wherein said treatment includes chemical binding of hydrophobic groups at least on the surface of said matter.

13. The method of claim 12, wherein said treatment is alkylation of functional groups present on the surface of said particulate matter.

14. The method of any one of the preceding claims, wherein said interface layer comprises catalytic components, for catalytic decomposition of volatile substances released from said animal waste, said catalytic component is introduced into said waste pool before or after introduction of said particulate matter into said pool, or while being sorbed onto said particulate matter.

15. The method of claim 14, wherein said catalytic component is a photo-catalytic component, being a complex or an oxide of a heavy metal.

16. The method of claim 15, wherein said heavy metal complex comprises a heavy metal selected from Fe, Cu, Co, or Ni.

17. The method of claim 15, wherein said metal oxide is TiO₂ or Al₂O₃.

18. The method of any one of the preceding claim, wherein said interface layer further comprises active carbon or carbon-derived substances introduced into said waste pool before or after introduction of said particulate matter or while being sorbed onto said particulate matter.

19. The method of any one of the preceding claims, wherein said interface layer comprises nano-particles having the diameter of 5-500 nm.

20. The method of any one of claims 1 to 18, wherein said interface layer comprises micro-particles or macro-particles having a diameter in the range of 1 μm to 5 cm.

21. The method of claims 1, 19 and 20, wherein said interface layer comprises a combination of nano-particles and micro- and/or macro-particles.

22. The method claim 1, comprising prior impregnation of said particulate matter with bacteria active for degradation of organic, biodegradable substances in said animal waste.

23. The method of any one of the preceding claims, being a batch process.

24. The method of any one of the preceding claims, comprising periodically adding additional animal waste to said receptacle.

25. Floatable porosive particulate matter, which after being introduced onto a pool containing liquid or semi-liquid animal waste forms an interface layer having an effect on said pool's upper layer composition or on its interaction with the overlaying atmosphere.

26. The particulate matter of claim 25, having 50-95% porosity.

27. The particulate matter of claim 26, being inherently hydrophobic or being treated to render at least part thereof hydrophobic.

28. The particulate matter of claim 25, comprising oxide-containing substances.

29. The particulate matter of claim 28, comprising silica-derived particles.

30. The particulate matter of claim 29, comprising mineral-derived particles.

31. The particulate matter of claim 30, wherein said mineral is selected from the group consisting of silica minerals, alumino minerals or clay minerals.

32. The particulate matter of claim 31, wherein said silica mineral is perlite and said clay mineral is bentonite or claydite.

33. The particulate matter of claim 28, comprising plant material residues.

34. The particulate matter of claim 33, wherein said plant material residues are selected from husk straw, peat, dry stems or sawdust.

35. The particulate matter of claim 27, wherein said treatment includes sintering of at least part of said porosive particulate matter to form air-filled pockets therein which renders said matter floatable.

36. The particulate matter of claim 27, wherein said treatment includes chemical binding of hydrophobic groups at least on the surface of said particulate matter.

37. The particulate matter of any one of the claims 25 to 36, comprising nano-particles having a diameter in the range of 5-500 nm.

38. The particulate matter of any one of claims 25-36, comprising micro- and/or macro-particles having a diameter in the range of 1 μm 5 cm.

39. The particulate matter of claims 37 and 38, wherein said nano-particles are sorbed onto said micro- or macro-particles prior to introduction thereof onto said animal waste.

40. The particulate matter of any one of claims 37 to 39, carrying sorbed onto said particles catalytic components, for catalytic decomposition of volatile substances.

41. The particles of claim 40, wherein said catalytic components are a heavy metal complex or oxide thereof.

42. The particles of claim 41, wherein said heavy metal complex comprises a heavy metal selected from Fe, Cu, Co or Ni.

43. The particulate matter of claim 41, wherein said metal oxide is TiO₂ or Al₂O₃.

44. The particulate matter of claim 38, wherein said nano-particles are sorbed onto active carbon or carbon-derived micro- or macro-particles.

45. The particulate matter of claim 25, being impregnated prior to introduction thereof onto said animal waste pool, with bacteria active for biodegradation of organic, biodegradable substances in said waste.

46. A system for the treatment of liquid or semi-liquid animal waste, comprising:
a. a receptacle for receiving the animal waste to form a waste pool;
b. floatable porosive particulate matter, which, when introduced onto said waste pool, forms an interface layer over a top surface of said pool, said interface layer having an effect on said pool's upper layer composition or on its interaction with the overlaying atmosphere.

47. The system of claim 46, wherein said particulate matter have 50-95% porosity.

48. The system of claim 46, wherein said particulate matter is inherently hydrophobic or is a hydrophilic particulate matter pre-treated to render at least part thereof hydrophobic.

49. The system of claim 46, further comprising catalytic components, for catalytic decomposition of volatile substances released from said animal waste.

50. The system of claim 49, wherein said catalytic component is a photo-catalyst.

51. The system of claim 46, further comprising active carbon or carbon-derived particles.

52. The system of claim 46, further comprising heat-absorbing particles and/or heating means for heating said waste pool.

53. An organic fertilizer composition comprising organic substances derived from animal waste, said organic substance being held in pores of porosive, nutritionally inert particulate matter.
